(19) United States
(12) Patent Application Publication
(10) Pub. No.: US 2014/0047043 A1
(43) Pub. Date: Feb. 13, 2014

(54) Disposable Email Address Generation and Mapping to a Regular Email Account

(71) Applicants: Cameron J. Esfahani, San Jose, CA (US); Carl J. Norum, San Jose, CA (US); Daniel R. Fletcher, Los Gatos, CA (US); James C. Murphy, San Jose, CA (US); Santo S. Sapienza, Sunnyvale, CA (US); Shachar Ron, Mountain View, CA (US); Stanley A. Rabu, Sunnyvale, CA (US)

(72) Inventors: Cameron J. Esfahani, San Jose, CA (US); Carl J. Norum, San Jose, CA (US); Daniel R. Fletcher, Los Gatos, CA (US); James C. Murphy, San Jose, CA (US); Santo S. Sapienza, Sunnyvale, CA (US); Shachar Ron, Mountain View, CA (US); Stanley A. Rabu, Sunnyvale, CA (US)

(73) Assignee: APPLE INC., Cupertino, CA (US)

(21) Appl. No.: 13/572,857

(22) Filed: Aug. 13, 2012

(51) Int. Cl. G06F 15/16

(52) U.S. Cl. 709/206

(57) ABSTRACT

An integrated system allows easily creating and using disposable email addresses. The disposable email address is created by an email server, which manages correspondence using the disposable email address to avoid exposing the associated non-disposable email address. Context information may be associated with a disposable email address, where the context information is not visible in email sent using the disposable email address. Expiration information may also be associated with the disposable email address, where the expiration information defines conditions that cause the disposable email address to expire. Should the disposable address be misused, the associated context may allow a user to recognize what correspondent exposed the disposable address to misuse.

### BACKGROUND

This disclosure relates generally to the field of electronic mail. More particularly, but not by way of limitation, it relates to techniques for generating and using disposable electronic mail (email) addresses that can be associated with a user-selected context information.

Email has become ubiquitous, and email addresses are requested often as postal addresses. When consumers use shopping websites to order goods or services, those websites typically request the consumer's email address to allow communication with the user about the order. Even paper forms filled out with pen and ink often request email addresses.

With the increased usage and importance of email also came, unfortunately, misuse of email addresses to send undesirable commercial email in bulk, the “junk mail” of the electronic world, often referred to as “spam.” Some reports have claimed that spam email accounts for 90% of all email, with trillions of spam emails being sent. Numerous approaches to stopping spam email from reaching the inbox of consumers have been tried, with varying degrees of success. But spam continues to be a problem for many people.

One class of techniques that has been tried in the past has involved the creation of what are known as “disposable email addresses.” Ordinary email addresses are often used for many years, and changing one's email address may require notifying numerous people and business entities, to avoid losing contact with friends or businesses, some of which may use email for important communications such as billing. The U.S. Postal Service provides a Change of Address form that allows temporary forwarding of postal mail to a new address. Although individual email servers may provide for forwarding emails from one address to another, those are often unavailable to someone who no longer has a business relationship with the former email provider. There is no central registry to allow even temporary automatic rerouting of email from an old email address to a new email address. So changing an email address can be painful.

Disposable email addresses are typically created so that email to the disposable email address is automatically forwarded to a non-disposable email address. The disposable email address thus hides the non-disposable email address from those to whom the disposable email address is given. Disposable email addresses are generally intended to have limited lifespans. Should the address be abused, such as by being included in a spam email campaign, the disposable email address can be deleted, without interfering with the consumer's normal email address. This avoids the need to create a new email address for regular use by consumer, as well as the need to inform the consumer's correspondents of the new address.

However, disposable email address systems are typically cumbersome to use, and may require obtaining the email address from a source other than the user's usual email provider. The result is that usage of disposable email addresses is very low. In addition, the disposable email address is often recognizable as being a disposable address. Some places that request email addresses when signing up for a service are known to analyze the email address and refuse to accept disposable email addresses. Should the user receive an email originally sent to the disposable address and forwarded to the non-disposable address, replies to that email generally get sent using the non-disposable address, thus exposing the non-disposable address for potential misuse.

In addition, if an email address (disposable or non-disposable) is given to multiple correspondents, one of which misuses the address or makes the address available to someone else that misuses it, there is generally no way to determine which of the multiple correspondents is responsible when the consumer starts getting a flood of spam sent to the email address.

### SUMMARY

An integrated system allows easily creating and using disposable email addresses. The disposable email address is created by an email server, which manages correspondence using the disposable email address to avoid exposing the associated non-disposable email address. Context information may be associated with a disposable email address, where the context information is not visible in email sent using the disposable email address. Should the disposable address be misused, the associated context may allow a user to recognize what correspondent exposed the disposable address to misuse.

A non-transitory program storage device is disclosed. The program storage device is readable by a programmable control device. Instructions are stored on the program storage device for causing the programmable control device to create a disposable email address associated with a context information, wherein the disposable email address does not include the context information; and associate the disposable email address with a non-disposable email address associated with a user.

Another non-transitory program storage device is disclosed. The program storage device is readable by a programmable control device. Instructions are stored on the program storage device for causing the programmable control device to allocate a disposable email address, the disposable email address independent of a non-disposable email address associated with a user; associate the disposable email address with the non-disposable email address; associate a context information with the disposable email address, external to the disposable email address; associate an expiration information with the disposable email address, external to the disposable email address; receive an email message addressed to the disposable email address; rewrite the email message, replacing the disposable email address with the non-disposable email address; provide the email message to an email client; receive a reply to the email message; and rewrite the reply, replacing the non-disposable email address with the disposable email address.

A programmable device is disclosed. The programmable device comprises a programmable control device; a network adapter, coupled to the programmable control device; and a memory coupled to the programmable control device. Instructions are stored in the memory, the instructions causing the programmable control device to receive a request for a disposable email address in a domain of a non-disposable email address; receive a context information associated with the disposable email address, wherein the context information is not contained in the disposable email address; receive an incoming email message addressed to the disposable email address; and provide the incoming email message to an email client associated with the non-disposable email address.

A method is disclosed. The method includes allocating a disposable email address in a domain of a non-disposable email address; associating a context information with the disposable email address, wherein the context information is external to the disposable email address; receiving an incoming email message addressed to the disposable email address; and providing the incoming email message to an email client associated with the non-disposable email address.

Another programmable device is disclosed. The programmable device includes a programmable control device; a network adapter, coupled to the programmable control device; and a memory coupled to the programmable control device. Instructions are stored in the memory, the instructions causing the programmable control device to request a disposable email address in a domain of a non-disposable email address from an email server associated with the domain; specify a context information associated with the disposable email address; receive the disposable email address from the email server; and create an outgoing email message indicating the disposable email address as a sender of the outgoing email message.

### BRIEF DESCRIPTION OF THE DRAWINGS

FIG. 1 is a flowchart illustrating a technique for an email client to request and use a disposable email address.

FIG. 2 is a flowchart illustrating a technique for an email server to process email received addressed to a disposable email address.

FIG. 3 is a flowchart illustrating a technique for an email client replying to an email sent to a disposable address.

FIG. 4 is a flowchart illustrating a technique for a server processing an email sent from an disposable email address.

FIG. 5 is a flowchart illustrating a technique for a browser plugin to request and use a disposable email address for using on a web form.

FIG. 6 is a block diagram illustrating a programmable device for implementing techniques for creating and using disposable email addresses.

FIG. 7 is a block diagram illustrating a network of email clients and an email server for implementing techniques for creating and using disposable email addresses.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

An email client and server provide an integrated system for creating and using disposable email addresses. The integration into a single system provides benefits beyond the web-based systems currently available today, which often are standalone systems for providing disposable email addresses, and are not integrated into an enterprises email infrastructure.

As used herein, an email address is a string of characters that identifies an email box to which email messages are delivered. The address generally consists of two parts, separated by an @: a local-part, often a user name of the recipient, and a domain, for example firstlast@apple.com.

An email message typically consists of a header portion, containing header records that are used by the email client and the email server for, among other things, determining the sender (the From: header) and the recipients (the To:, cc:, and bcc: headers). Other header information may be used for other purposes, including anti-spam information and headers for allowing clients and servers to track threads or conversations of email messages. The body portion of the email message contains the actual text of the message.

As used herein, an email client is software for allowing a user to read received email and create email to be sent. The email client software may be an application installed on a programmable device, or may be a web-based application as desired accessed through a web browser interface. The email client interacts with an email server for delivering mail to and from the email client. The email client may access email stored locally on the programmable device and/or stored remotely and managed by the email server.

As used herein, an email server is a system for processing emails received for delivery to a user and for processing emails received from the user for delivery to another user. The email server typically processes emails for multiple users, but may be a single user server if desired. The email server is configured to process email for one or more domains associated with the email server and the email clients with which it communicates.

The email server provides storage for email or may access an email store on a remote system. Software for implementing the email server may execute on one or more computer systems, connected to the email client via one or more networks. Although generally described herein as being separate systems, implementations may include integrated systems in which the client and server are both installed on a single computer system.

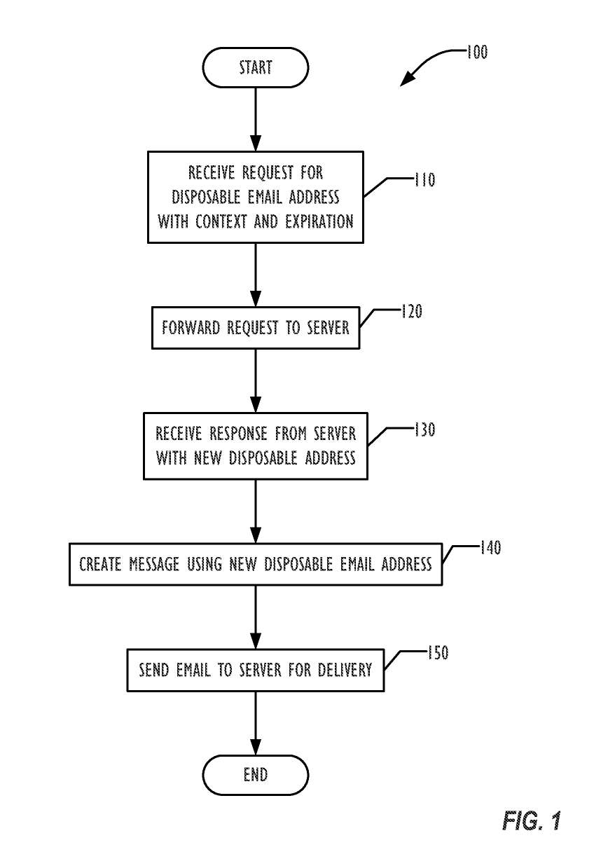

FIG. 1 is a flowchart illustrating a technique 100 for using disposable email addresses in an email client software. In block 110, the email client receives a request for a disposable email address from user through a user interface. The user may provide with the request context information and expiration information. Any desired user interface may be provided by the email client for requesting the creation of a disposable email address, including drop-down menus, pop-up windows, etc. The user need not specify any particular desired disposable email address, although some implementations may allow the user to include a desired address as part of the request.

Preferably, the email client merely requests a disposable email address from the email server, without having to specify any part of the address. The disposable address does not contain either the context information or the expiration information, and preferably is indistinguishable from an ordinary non-disposable email address, to avoid or lessen the likelihood that a recipient would be able to recognize the address as a disposable email address and take any actions based upon that recognition. For example, if email addresses associated with the email server normally have a format of FirstName.LastName@domain.com, then disposable email addresses preferably would be created in such a format, where the first name and last name are not the names of the person associated with the non-disposable email address corresponding to the disposable email address.

The context information may be any arbitrary information provided by the user. The context information may be used by the user to provide an association between the disposable email address and a use of that address. For example, a user wanting to provide an email address to a vendor may provide context information that the user may use to associate the disposable email address with the vendor, such as the identity of the vendor. Should the user later receive spam email from a source other than the vendor addressed to the disposable email address, the user may examine the context associated with that email address to identify who was provided that disposable email address. Implementations may make the context information available to the user in-band in the received email message or out of band in a user interface as desired. The user may then use that information to complain to the vendor about providing the disposable email address to the other source or take any other desired action. Provision of the context information is preferably optional, allowing a user to omit providing the context information if desired. However, some implementations may require provision of context information with every request for a disposable address. Use of the context information to track back to the person or entity that was originally provided the disposable address is illustrative and by way of example, and the user may make any desired use of the context information.

Some implementations may impose a structure or rules upon the context information, including a maximum or minimum length, restricting the information that may be provided as the context information. Some implementations may provide a default context information, such as a date stamp, to assist the user in determining what context information to provide.

Any desired user interface may be provided as part of the email client for obtaining the context information. For example, the context information may be provided with the request for the disposable email address, or the user may be asked to provide the context information as part of processing the request. Implementations may also provide default or automatically created context information if desired.

Expiration information may also be provided as part of the request. The expiration information indicates the conditions that will cause the disposable email address to expire automatically, invalidating the email address. Those conditions may include: (a) the address expires after a predetermined number of uses, such as after a single use or after 10 uses; and (b) the address expires after a predetermined amount of time, such as 1 day or 1 month after creation. These expiration conditions are illustrative and by way of example only, and any desired expiration condition may be provided, and combinations of conditions may be used. More complex conditions may be provided, such as expiring the address after receipt of an email that is considered spam by the email server. Some implementations may provide for the creation of rules to define the expiration condition or conditions. As with the context information, provision of expiration information is optional, and may be omitted by the user making the request for the disposable email address. Implementations may provide for a configurable default expiration, such as a default that the disposable email address expires 1 week after creation of the disposable email address.

After receiving the request and optionally the context and expiration information, in block 120 the email client forwards the request and associated information to the server. Alternately, the client may forward the request to the server without the context or expiration information, and then provide that information to the server responsive to a request from the server for the information. The email server may then create the disposable email address and respond to the request with information about the disposable email address in block 130.

Any desired protocol or communications technique may be used for communicating between the email client and the email server, and the protocol may be the same as or different from the protocol used for sending email messages between the client and server. In some implementations, the information related to the disposable email address is provided to the server in the header information of the email message sent to the server to deliver. Other implementations may use an out-of-band protocol for transmitting and receiving information related to the disposable email address.

Once the email client has received the disposable email address, the client may then in block 140 create an email message using the disposable email address as the address of the sender. The email client does not need to retain information about the disposable email address and its associated context and expiration information after the email message created using that disposable email address is sent to the email server for delivery in block 150, although the email client may do so if desired.

Blocks 140 and 150 may be separated in time from blocks 110-130, allowing the email client to pre-provision a disposable email address, then use that disposable address at a later time for creating an email message to be delivered indicating the email message is from the disposable email address. An email client may request more than one disposable email address. The email server may be configured with limits on how many active disposable email addresses may be associated with a non-disposable email address.

Although not illustrated in FIG. 1 for clarity, email clients may provide a user interface to allow users to select between multiple disposable email addresses when sending an email. Implementations may include any desired user interface technique, such as a popup menu to allow the selection. The popup menu may display other information in addition to the disposable email address itself, such as any available context information and expiration information associated with that disposable email address.

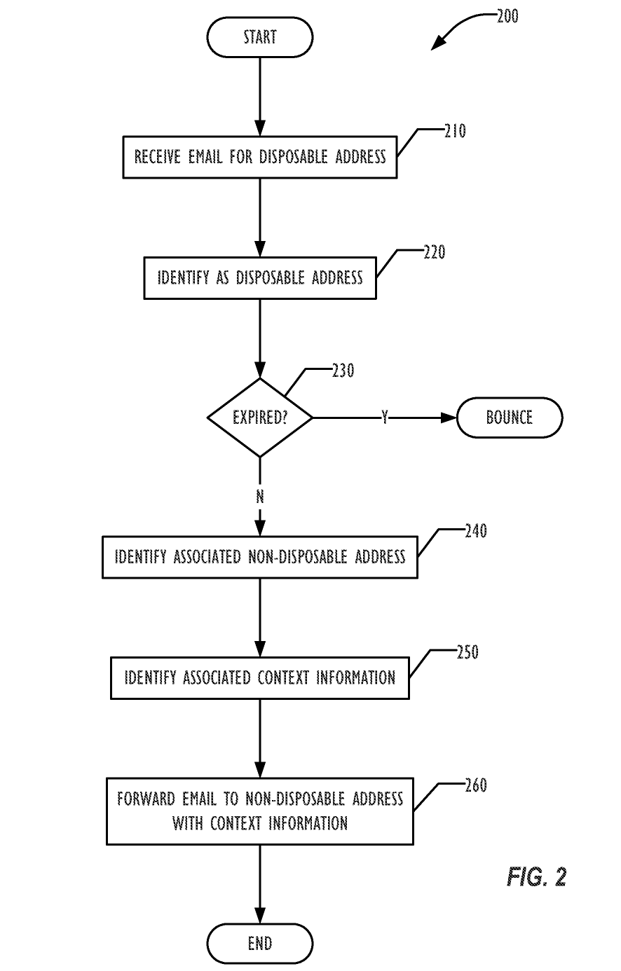

FIG. 2 is a flowchart illustrating a technique 200 for an email server to process an email received addressed to a disposable email address. The email server forwards the email to the non-disposable address associated with the disposable email address, as explained in detail below.

In block 210, the email server receives an email addressed to a disposable email address. As will be understood by one of skill in the art, the disposable email address may be identified as any of multiple recipients of an email, including one that is a blind copy recipient in which the address is not contained in the header information of the message that is to be presented to the user, but is contained in the Simple Mail Transport Protocol (SMTP) envelope.

The email server then examines the email message in block 220, identifying the recipient email address as a disposable email address. This may involve querying a database of address information stored by the email server. In the case of a disposable email address, the database entry for the address indicates that the address is a disposable email address, requiring additional processing beyond the usual handling of an email addressed to a valid email address.

In block 230, the email server determines whether the disposable email address is an expired address. As indicated above, this determination may involve date calculations, if the disposable email address was created with a predetermined expiration date. If the disposable email address was created with usage count restrictions, then the email server determines whether a usage count threshold value has been exceeded. For example, if the disposable email address was created to allow receiving only a single message to that address, and this is the second time such a message has been received, the disposable email address may be considered as expired. Other conditions, and more complex conditions, including combinations of conditions, may be evaluated to determine whether the disposable email address has expired. The email server may apply rules created when the disposable email address was created as part of that determination.

Implementations may allow the user to manage those rules after their initial creation. For example, the user may wish to update the usage count threshold value. Implementations may allow the user to enumerate, edit, and delete any characteristic associated with the disposable email address, including the mapping between the disposable email address and a non-disposable email address. The email client may allow such capability, such as via a specialized user interface; alternately, a server-based approach may provide a web interface or custom application to perform rule maintenance on the server.

If the disposable email address is determined in block 230 to be expired, then the disposable email address is no longer a valid address, and the email is refused (generally referred to as bouncing the message), just as if the sender had attempted to send to an unknown addressee, preferably with no indication in whatever refusal message is returned to the sender that the message was bounced because it was addressed to an expired disposable email address.

If the disposable email address has not yet expired, then in block 240 the non-disposable email address associated with the disposable email address is identified. In block 250, the associated context information is also identified. The email server then in block 260 reroutes or forwards the email to the non-disposable email address with the context information. Although described as forwarding, instead of creating a new message to forward the original message to the non-disposable address, the email server may rewrite the email address information in the header of the email message, replacing the disposable email address with the associated non-disposable email address in the appropriate header or headers. If the address information is rewritten, the email server may also insert a new header into the email message with information identifying the original disposable email address. In some implementations, the body of the email message may also be rewritten, replacing references to the disposable email address with the non-disposable email address wherever found.

The email server tags the email message with the context identifier, providing the context information to the user. The context information may be added to the email message when delivered to the non-disposable address as a new header record in the header portion of the email message. The disposable email address and context information may be combined into a single header if desired. The header or headers inserted by the email server may be have a proprietary format specific to the email client and email server, typically with a header name identified with an X-prefix. Alternatively, an out-of-band protocol may convey the context information and the disposable email address information to the email client upon delivery of the email message to the email client. In another alternative, the email message is not modified for delivery to the email client, but is delivered with the disposable email address as it was received by the email server.

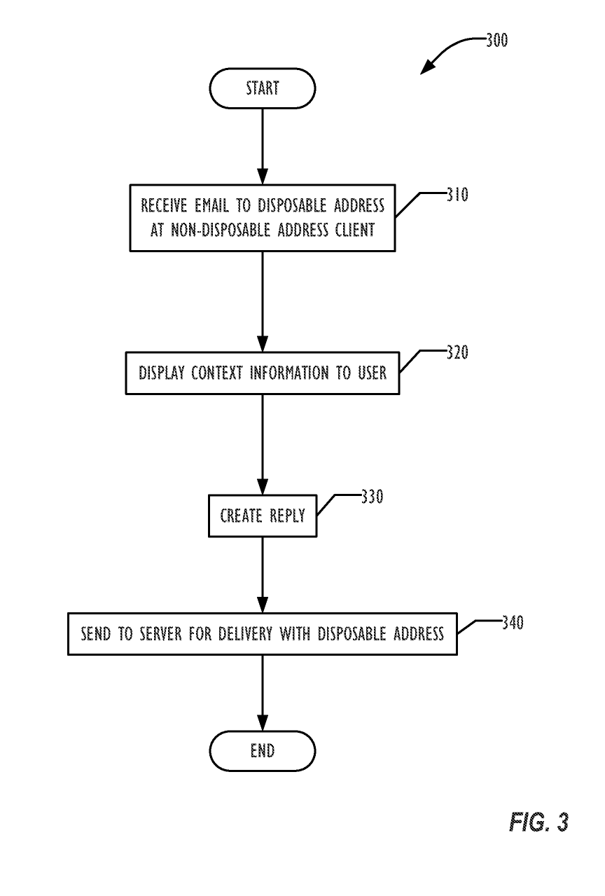

FIG. 3 is a flowchart illustrating a technique 300 for replying to email that was received addressed to a disposable email address. As described above in FIG. 2, the email server upon receiving an email addressed to a disposable email address delivers the email to the associated non-disposable email address. Upon receipt in block 310, the email client recognizes that the email was originally addressed to the disposable email address. Either automatically, or upon receiving a request by a user of the email client, the context information associated with the disposable email address may be displayed to the user in block 320, allowing the user to take any desired action based on that context information. The action taken by the user may be external to the email client.

In block 330, the email client creates a reply to the email message originally sent to the disposable email address. In block 340, the reply is sent to the email server for delivery using the disposable address as the From address, hiding the non-disposable email address. During the creation of the reply, the disposable email address may be visible or invisible to the user of the email client, as desired. Thus, the email client may present information to the user indicating that the reply email message is to be sent from the non-disposable email address, but when delivering the reply message to the server, indicating that the reply email message is to be sent using the disposable email address as the From address. Alternately, the email client may indicate that the reply message is from the disposable email address during the creation of the reply email. Similar to the technique for delivering the original email addressed to the disposable email address to the email client, the communication between the email client and email server related to the disposable email address may be in-band, contained in a header of the email message, or out-of-band, using a protocol for communicating the disposable email address from the email client to the email server outside of the reply email message itself. Regardless, the email server delivers the reply message using the disposable email address as the From address, rather than the associated non-disposable email address.

In some implementations, the reply email may be created using the non-disposable email address. In such an implementation, the email server recognizes that the reply email is a reply to an earlier email message addressed to the disposable email address, typically using information in the email header portion for keeping track of message threads or conversations. The email server may then rewrite the reply email, replacing the disposable email address with the non-disposable email address. Such capability would allow an email server to handle disposable email addresses properly when dealing with an email client that is unaware of or incapable of dealing with disposable email addresses.

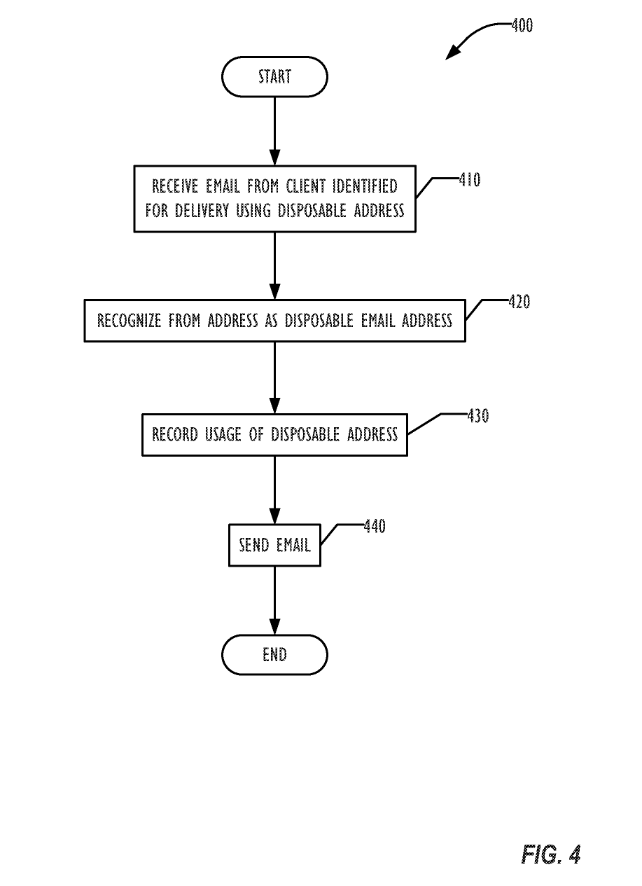

FIG. 4 is a flowchart illustrating a technique 400 for sending an email created by the email client for delivery using a disposable email address. In block 410, the email server receives an email from the email client, where the email is configured to indicate that the disposable email address is the sending party (the From address). The email server analyzes the email message and any other information provided by the email client to recognize that the From address is a disposable email address in block 420. In block 430, the email server records usage of the disposable address, such as updating a counter of emails sent from that address. If the email client provided the email message to the server with the non-disposable email address as the From address, and used a header in the email or out-of-band information to indicate that it should be sent from the disposable email address instead of the non-disposable email address, the email server may have to rewrite the header information of the email message to replace the non-disposable email address of the From header with the disposable email address.

The technique 400 illustrated in FIG. 4 assumes that the email client incorporates the disposable email address in the From address before sending the email for delivery. In other implementations, the email client transmits the email with a non-disposable From address, and the email server modifies the email to use the disposable email address.

The email server may also keep track of recipient addresses associated with disposable email addresses. For example, the recipient address may be associated with the context information when creating a disposable email address intended for use with the recipient. In such an implementation, if the From address is a non-disposable email address, but the recipient (To, CC, or BCC) address is recognized as one associated with a disposable email address, the email server may rewrite the From address to use the disposable email address. Such an implementation may allow an email client that is unaware of or incapable of using disposable email addresses to reap the benefits of the disposable email address capability managed by the server.

Then in block 440, the email server delivers the email message to the email system or systems handling email for the recipient or recipients, using conventional email delivery techniques.

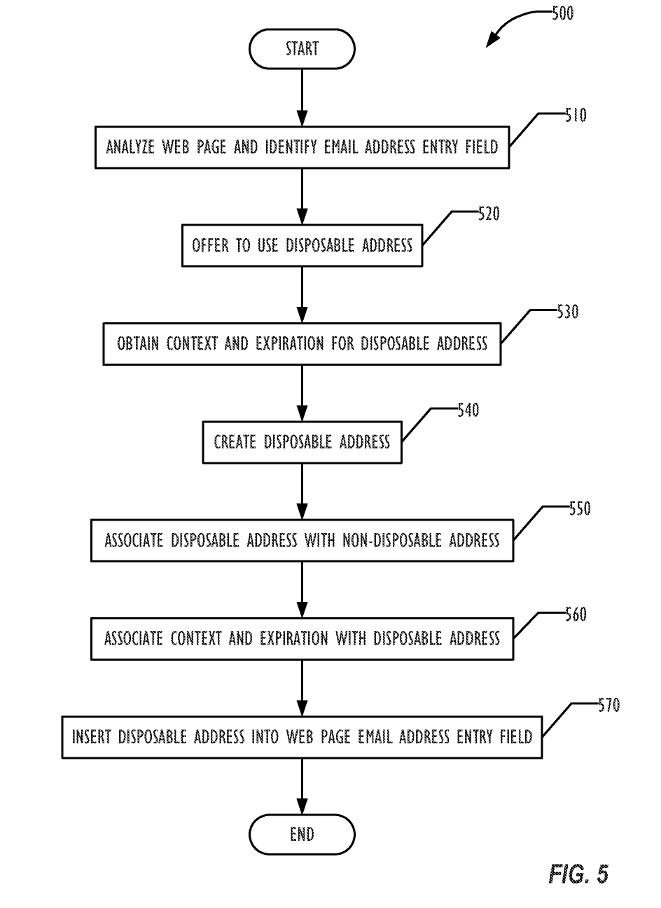

In addition to scenarios where an email client and an email server interact to handle email messages with disposable email addresses, a web browser plugin or extension may provide a way for a user to complete a web-based form requesting an email address with a disposable email address. FIG. 5 is a flowchart illustrating a technique 500 for providing an easy to use way for users to provide disposable email addresses to web forms, without having to transition away from the web page to another application, request a disposable email address, copy the new address to the clipboard, then transition back to the web page and paste the address into the form.

In block 510, the plugin may analyze a web page received by a browser and identify an email address entry field. In block 520, the browser plugin may offer the user an opportunity to fill the field with a disposable email address. In one implementation, a mouseover event is triggered by moving the mouse over the email address entry field to cause a message to be displayed asking the user whether to create a disposable email address. If the user chooses to use a disposable email address, then in block 530 context and/or expiration information may be requested for association with the disposable email address. Once that information, including any default values that may be configured for the plugin, is obtained by the plugin (or the user has declined to provide such information), in block 540 the disposable email address is created by the email server. In block 550, the disposable email address is associated with a non-disposable email address such as the user's normal email address and the context and expiration information is associated in block 560 with the disposable email address, all of which are provided to the email server during the creation of the disposable email address. In implementations where a user may have multiple non-disposable email addresses available, a user interface element may allow the user to choose which non-disposable address should be associated with the newly created disposable address. Then in block 570 the disposable email address may be automatically inserted into the email address entry field of the web page. Then, should the user submit the web-based form, the disposable email address will be provided in the email address field, and may be used by the person or entity providing the web page.

Implementation in an Programmable Device

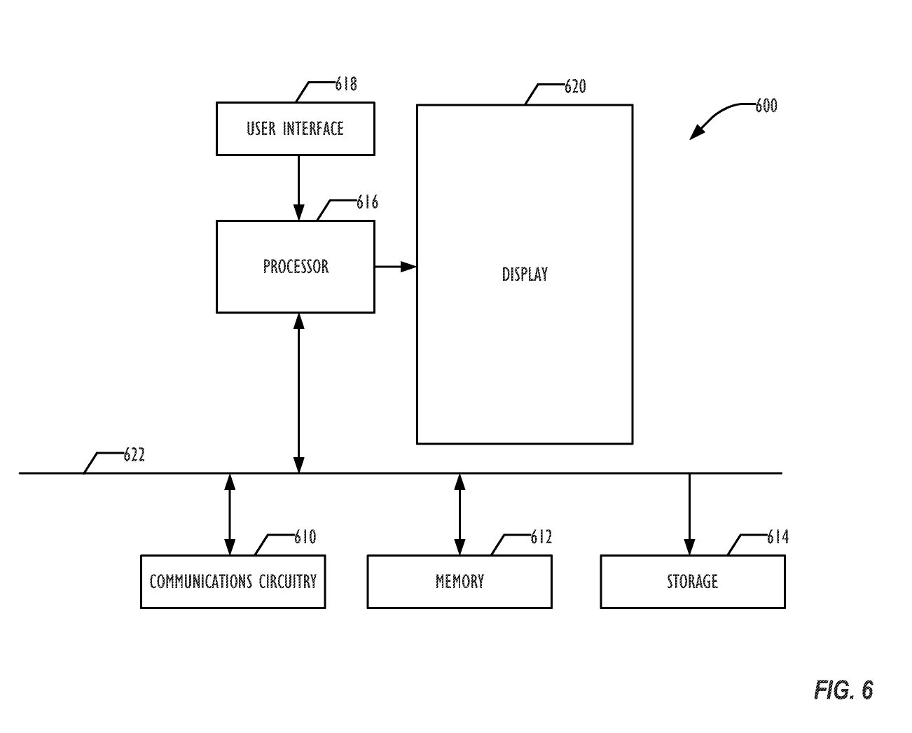

FIG. 6 is a simplified functional block diagram illustrating an programmable device 600 according to one embodiment that can implement the techniques described above. The programmable device 600 may include one or more processors 616, display 620, communications circuitry 610, user interface 618, memory 612, storage device 614, and communications bus 622. Processor 616 may be any suitable programmable control device and may control the operation of many functions performed by programmable device 600. Processor 616 may drive display 620 and may receive user inputs from the user interface 618. An embedded processor provides a versatile and robust programmable control device that may be utilized for carrying out the disclosed techniques.

Storage device 614 may store media (e.g., image and video files), software (e.g., for implementing various functions on device 600), preference information, device profile information, and any other suitable data. Storage device 614 may include one more storage mediums for tangibly recording image data and program instructions, including for example, a hard-drive or solid state memory, permanent memory such as ROM, semi-permanent memory such as RAM, or cache. Program instructions may comprise a software implementation encoded in any desired language (e.g., C or C++).

Memory 612 may include one or more different types of memory which may be used for performing device functions. For example, memory 612 may include cache, ROM, and/or RAM. Communications bus 622 may provide a data transfer path for transferring data to, from, or between at least storage device 614, memory 612, and processor 616. Although referred to as a bus, communications bus 622 is not limited to any specific data transfer technology. User interface 618 may allow a user to interact with the programmable device 600. For example, the user interface 618 can take a variety of forms, such as a button, keypad, dial, a click wheel, a mouse, or a touch screen.

In one embodiment, the programmable device 600 may be an programmable device capable of processing and displaying electronic mail messages. For example, the programmable device 600 may be a device such as such a mobile phone, personal data assistant (PDA), monitor, television, laptop, desktop, and tablet computer, or other suitable personal device.

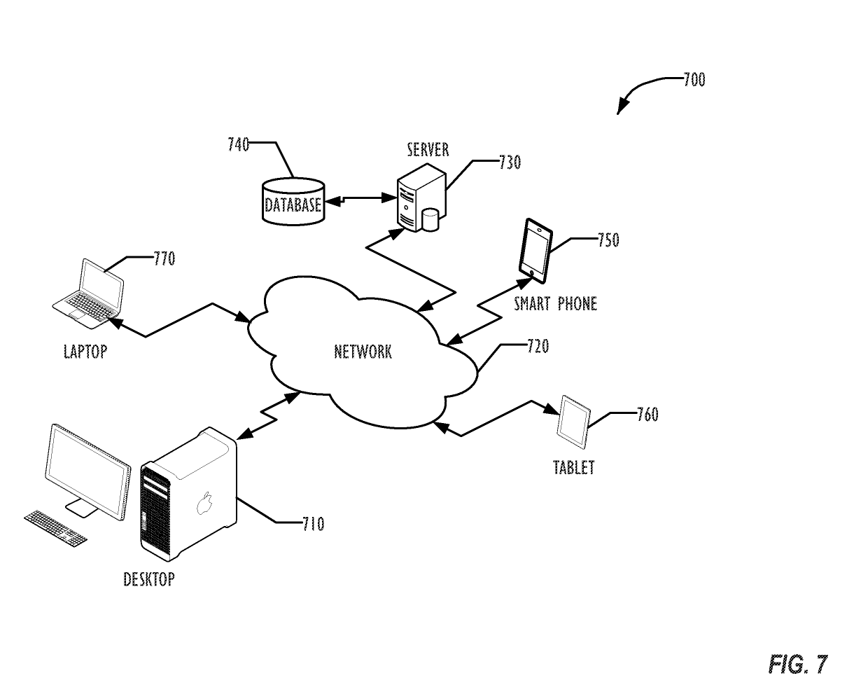

FIG. 7 is a block diagram illustrating a system 700 of networked devices for implementing the techniques described above. The email client described above may be implemented on any of the desktop computer 710, smart phone 750, tablet 760, or laptop 770, for example. Each of these devices is connected by one or more networks 720 to the email server 730, to which is coupled a database 740 for storing information about disposable email addresses and their associated information. The database 740 may be any desired form of data storage, including structured databases and non-structured flat files. The email server 730 may also provide remote storage for email messages that have been or are to be delivered to the email clients on devices 710, 750, 760, and 770, either in the database 740 or in a different database (not shown).

Although a single network 720 is illustrated in FIG. 7, the network 720 may be multiple interconnected networks, and the email server 730 may be connected to each of the email clients on devices 710, 750, 760, and 770 via different networks 720. The network 720 may be any type of network, including local area networks, wide area networks, or the global internet.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A non-transitory program storage device, readable by one or more programmable control devices, comprising instructions stored thereon for causing one or more of the programmable control devices to:
create a disposable email address associated with a context information, wherein the disposable email address does not include the context information; and
associate the disposable email address with a non-disposable email address.

2. The program storage device of claim 1, wherein the instructions stored thereon further comprise instructions for causing one or more of the programmable control devices to:
provide the disposable email address to an email client.

3. The program storage device of claim 1, wherein the instructions stored thereon further comprise instructions for causing one or more of the programmable control devices to:
receive a request for the disposable email address from an email client.

4. The program storage device of claim 1, wherein the instructions stored thereon further comprise instructions for causing one or more of the programmable control devices to:
receive a request for the disposable email address from a web browser plugin.

5. The program storage device of claim 1, wherein the disposable email address does not contain the non-disposable email address.

6. The program storage device of claim 1, wherein the instructions stored thereon further comprise instructions for causing one or more of the programmable control devices to:
receive an expiration information associated with the disposable email address, wherein the expiration information indicates a condition that when met invalidates the disposable email address.

7. The program storage device of claim 1, wherein the instructions stored thereon further comprise instructions for causing one or more of the programmable control devices to:
receive an email message addressed to the disposable email address;
reroute the email message to the non-disposable address associated with the disposable email address; and
provide the context information associated with the disposable email address with the email message.

8. The program storage device of claim 7, wherein the instructions stored thereon further comprise instructions for causing one or more of the programmable control devices to reroute the email message to the non-disposable address comprise instructions for causing one or more of the programmable control devices to:
rewrite the email message, replacing the disposable email address with the associated non-disposable email address; and
rewrite a reply to the email message, replacing the associated non-disposable email address with the disposable email address.

9. The program storage device of claim 7, wherein the instructions stored thereon further comprise instructions for causing one or more of the programmable control devices to:
reject the email message if the disposable email address has expired.

10. The program storage device of claim 1, wherein the disposable email address is in a domain associated with the associated non-disposable email address.

11. A non-transitory program storage device, readable by one or more programmable control devices, comprising instructions stored thereon for causing one or more of the programmable control devices to:
allocate a disposable email address, the disposable email address independent of a non-disposable email address;
associate the disposable email address with the non-disposable email address;
associate a context information with the disposable email address, external to the disposable email address;
associate an expiration information with the disposable email address, external to the disposable email address;
receive an email message addressed to the disposable email address;
rewrite the email message, replacing the disposable email address with the non-disposable email address;
provide the email message to an email client;
provide the context information to the email client;
receive a reply to the email message; and
rewrite the reply, replacing the non-disposable email address with the disposable email address.

12. The program storage device of claim 11, wherein the instructions for causing one or more of the programmable control devices to rewrite the email message comprise instructions for causing one or more of the programmable control devices to:
replace the disposable email address with the non-disposable email address in both a header portion of the email message and a body portion of the email message.

13. The program storage device of claim 11, wherein the instructions stored thereon further comprise instructions for causing one or more of the programmable control devices to:
provide the context information with the email message to the email client.

14. A programmable device, comprising:
one or more programmable control devices;
a network adapter, coupled to the programmable control devices; and
a memory coupled to the programmable control devices, wherein instructions are stored in the memory, the instructions causing one or more of the programmable control devices to:
receive a request for a disposable email address in a domain of a non-disposable email address;
receive a context information associated with the disposable email address, wherein the context information is not contained in the disposable email address;
receive an incoming email message addressed to the disposable email address; and
provide the incoming email message to an email client associated with the non-disposable email address.

15. The programmable device of claim 14, wherein the instructions stored in the memory further comprise instructions for causing one or more of the programmable control devices to:
provide the disposable email address to the email client.

16. The programmable device of claim 14, wherein the instructions stored in the memory further comprise instructions for causing one or more of the programmable control devices to:
receive an expiration information associated with the disposable email address.

17. The programmable device of claim 16, wherein the instructions stored in the memory further comprise instructions for causing one or more of the programmable control devices to:
reject the incoming email message if the expiration information indicates that the disposable email address has expired.

18. The programmable device of claim 14, wherein the instructions for causing one or more of the programmable control devices to receive a request for a disposable email address in a domain of a non-disposable email address comprise instructions for causing one or more of the programmable control devices to:
receive an outgoing email message from an email client, wherein the outgoing email message contains a request to allocate a disposable email address and to replace the non-disposable email address in the outgoing email message with the disposable email address.

19. The programmable device of claim 18, wherein the request is contained in a header of the outgoing email message.

20. The programmable device of claim 18, wherein the instructions for causing one or more of the programmable control devices to provide the incoming email message to an email client associated with the non-disposable email address further comprise instructions for causing one or more of the programmable control devices to:
rewrite the incoming email message, replacing the disposable email address with the non-disposable email address.

21. The programmable device of claim 14, wherein the instructions for causing one or more of the programmable control devices to provide the incoming email message to an email client associated with the non-disposable email address comprise instructions for causing one or more of the programmable control devices to:
add an indication to the incoming email message indicating that the message was addressed to the disposable email address.

22. The programmable device of claim 14, wherein the instructions stored in memory further comprises instructions causing one or more of the programmable control devices to:
create, edit, and delete information associated with the disposable email address.

23. A method, comprising:
allocating a disposable email address in a domain of a non-disposable email address;
associating a context information with the disposable email address, wherein the context information is external to the disposable email address;
receiving an incoming email message addressed to the disposable email address; and
providing the incoming email message to an email client associated with the non-disposable email address.

24. The method of claim 23, further comprising:
sending an outgoing email message indicating the disposable email address as a sender of the outgoing email message.

25. The method of claim 23, wherein providing the incoming email message to an email client associated with the non-disposable email address comprises:
replacing the disposable email address with the non-disposable email address in the incoming email message.

26. The method of claim 23, further comprising:
receiving an outgoing email message replying to the incoming message; and
sending the outgoing email message indicating the disposable email address as a sender of the outgoing email message.

27. The method of claim 23, further comprising:
determining whether the disposable email address has expired; and
rejecting the incoming email message if the disposable email address has expired.

28. A programmable device, comprising:
one or more programmable control devices;
a network adapter, coupled to the programmable control devices; and
a memory coupled to the programmable control devices, wherein instructions are stored in the memory, the instructions causing one or more of the programmable control devices to:
request a disposable email address in a domain of a non-disposable email address from an email server associated with the domain;
specify a context information associated with the disposable email address;
receive the disposable email address from the email server; and
create an outgoing email message indicating the disposable email address as a sender of the outgoing email message.

29. The programmable device of claim 28, wherein the instructions stored in memory causing one or more of the programmable control devices to specify a context information comprise instructions causing one or more of the programmable control devices to:
send the context information to the email server.

30. The programmable device of claim 28, wherein the instructions stored in memory causing one or more of the programmable control devices to create an outgoing email message indicating the disposable email address as a sender of the outgoing email message comprise instructions causing one or more of the programmable control devices to:
create an outgoing email message indicating the non-disposable email address as a sender of the outgoing email message;
flag the outgoing email message for delivery indicating the disposable email address as a sender of the outgoing email message; and
sending the flagged outgoing email message to the email server.
